(19) United States
(12) Patent Application Publication
(10) Pub. No.: US 2008/0134469 A1
(43) Pub. Date: Jun. 12, 2008

(54) SLIDING HINGE AND ELECTRONIC DEVICE USING THE SAME

(75) Inventors: Jun-Hai Zhang, Jiangsu Province (CN); Xiang-Lin Li, Jiangsu Province (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignees: QISDA CORPORATION, Taoyuan Shien (TW); BENQ CORPORATION, Taipei (TW)

(21) Appl. No.: 11/869,815

(22) Filed: Oct. 10, 2007

(30) Foreign Application Priority Data
Dec. 6, 2006 (TW) 95145516

(51) Int. Cl. E05D 15/00

(52) U.S. Cl. 16/362

(57) ABSTRACT

A sliding hinge and an electronic device using the same are provided. The sliding hinge comprising a base and a sliding element is disposed between a first assembly and a second assembly of the electronic device. The base comprising an elastic portion is disposed on the first assembly. The sliding element comprising an adapting portion against the elastic portion is disposed on the second assembly and is coupled with the base. When the first assembly slides relatively to the second assembly, the elastic portion provides an elastic force to the adapting portion for pushing the sliding element, such that the sliding element slides between the first position and the second position on the base.

This application claims the benefit of Taiwan application Serial No. 95145516, filed Dec. 6, 2006, the subject matter of which is incorporated herein by reference.

### BACKGROUND OF THE INVENTION

1. Field of the Invention

The invention relates in general to a sliding hinge and an electronic device using the same, and more particularly to a sliding hinge with multi-stage stopping function and an electronic device using the same.

2. Description of the Related Art

As the electronic devices such as mobile phone, PDA, digital camera are getting more and more diversified, consumers also have higher expectation of product functions. Electronic devices with a sliding cover design such as slide type mobile phone and slide type PDA have gained a great popularity. Despite the slide type electronic products have become popular, the sliding hinge used in slide type electronic products has only a limited variety, and some of the sliding hinge is costive due to complicated structural design.

A new invention of sliding assembly used in slide type mobile phone is disclosed in Chinese Patent Publication No. CN2798518. According to the sliding assembly disclosed in CN2798518 patent, a plurality of single-layered spring pieces are disposed between the main body and the sliding body of the mobile phone, wherein one end of the spring pieces is disposed on the main body, and the other end is disposed on the sliding body. When the user applies a force on the sliding body, the spring pieces are pressed for generating a pushing force between the main body and the sliding body, such that the sliding body moves relatively to the main body. However, such design, which requires a plurality of spring piece to be assembled on the main body and the sliding body and involves a large number of parts and a complicated assembling, is not economical in terms of efficiency, cost and manufacturing process.

Also, a mobile phone and a sliding unit thereof are disclosed in Japanese Patent Publication No. JP2006-050204. The sliding unit disclosed in JP2006-050204 is constituted by two symmetric torsional springs. The torsional springs each has two pins, wherein one pin is fixed on the body of the mobile phone and the other pin is fixed on the sliding cover of the mobile phone. When the user applies a force to slide the sliding cover, the symmetric torsional springs will apply an elastic force on the sliding cover to assist the movement of the sliding cover. However, the angle between the pins of the torsional springs as well as the location of the pins of the torsional spring disposed on the body and the sliding cover all need to be accurately designed, such that the sliding cover slides smoothly on the body. Thus, the torsional springs are costive and are difficult to be assembled, hence incurring more manufacturing cost of the mobile phone.

### SUMMARY OF THE INVENTION

The invention is directed to a sliding hinge and an electronic device using the same. The base and the sliding element of the sliding hinge are respectively disposed on the first assembly and the second assembly of the electronic device. As the base is coupled with the sliding element, the first assembly is capable of sliding relatively to the second assembly. The adapting portion of the sliding element is against the elastic portion of the base and presses the elastic portion when the sliding element slides.

According to a first aspect of the present invention, a sliding hinge including a base and a sliding element is provided. The base has an elastic portion. The sliding element is coupled with the base and has an adapting portion against the elastic portion. When the sliding element slides on the base, the elastic portion provides an elastic force to the adapting portion for pushing the sliding element, such that the sliding element slides between a first position and a second position on the base.

According to a second aspect of the present invention, an electronic device including a first assembly, a second assembly and a sliding hinge is provided. The sliding hinge including a base and a sliding element is disposed between the first assembly and the second assembly. The base has an elastic portion. The sliding element having an adapting portion against the elastic portion is coupled with the base. When the first assembly slides relatively to the second assembly, the elastic portion provides an elastic force to the adapting portion for pushing the sliding element, such that the sliding element slides between a first position and a second position on the base.

The invention will become apparent from the following detailed description of the preferred but non-limiting embodiments. The following description is made with reference to the accompanying drawings.

### BRIEF DESCRIPTION OF THE DRAWINGS

FIG. 1 is a diagram of a sliding hinge according to a preferred embodiment of the invention;

FIG. 2A is a diagram of the base in FIG. 1;

FIG. 2B is a diagram of the sliding element in FIG. 1;

FIG. 3A is a perspective of the sliding element in FIG. 1 at the first position;

FIG. 3B is a perspective of the sliding element in FIG. 1 at the second position;

FIGS. 4A˜4B are perspectives showing the movements of the sliding hinge with stopping point design for the sliding element; and

FIG. 5 is a diagram of an electronic device of the invention.

### DETAILED DESCRIPTION OF THE INVENTION

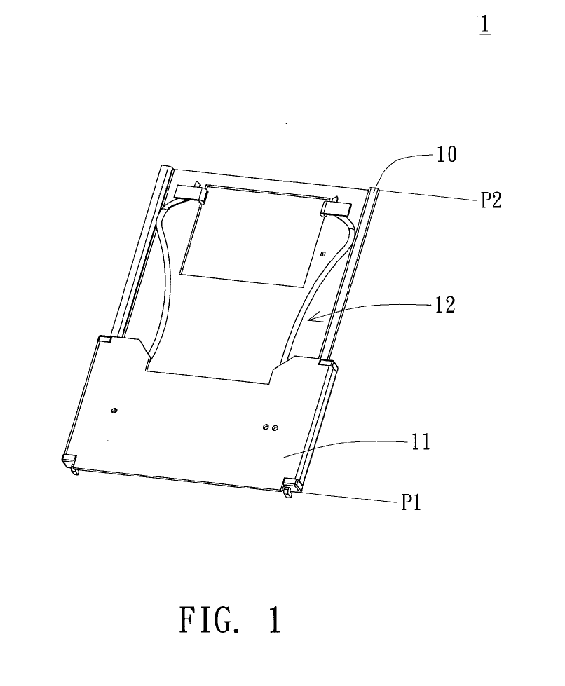

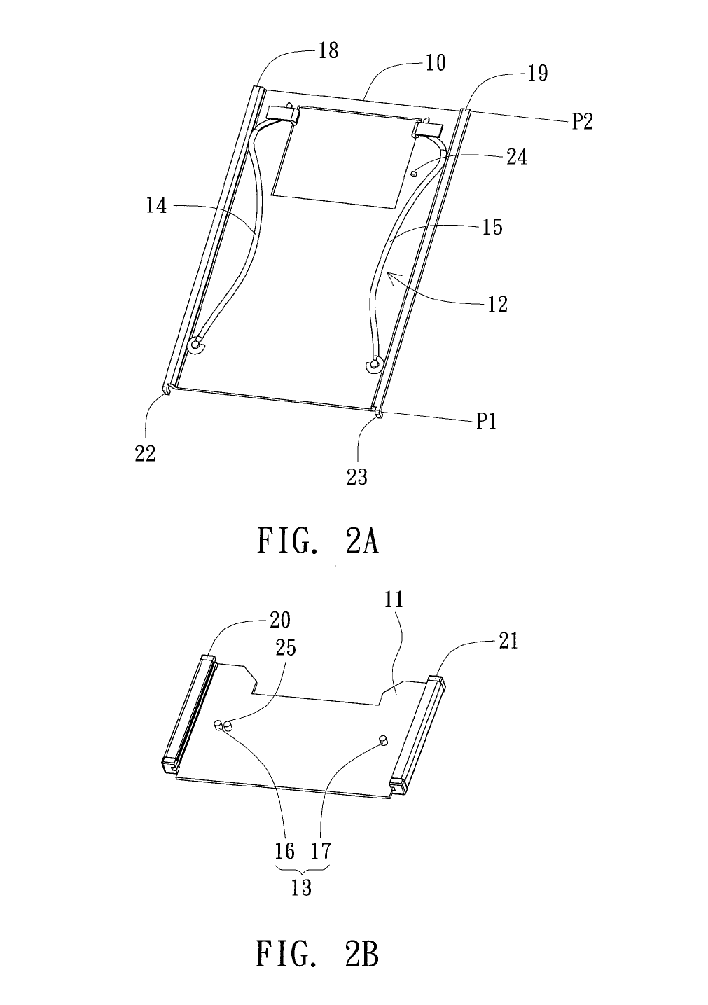

Referring to FIG. 1, a diagram of a sliding hinge according to a preferred embodiment of the invention is shown. As indicated in FIG. 1, the sliding hinge 1 includes a base 10 and a sliding element 11 coupled with the base 10. The sliding element 11 is slideably coupled with the base 10. The base 10 includes an elastic portion 12. The sliding element 11 includes an adapting portion 13 (referring to FIG. 2B) against the elastic portion 12. When the sliding element 11 slides on the base 10, the elastic portion 12 provides an elastic force to the adapting portion 13 for pushing the sliding element 11, such that the sliding element 11 slides between the first position P1 and the second position P2 on the base 10.

Referring to FIGS. 2A˜2B, FIG. 2A is a diagram of the base in FIG. 1, and FIG. 2B is a diagram of the sliding element in FIG. 1. As indicated in FIG. 2A, the elastic portion 12 has two elastic elements 14 and 15 symmetrically disposed on the base 10, wherein one end of each of the two elastic elements 14 and 15 is adjacent to the first position P1 on the base 10, and the other end of each of the elastic elements 14 and 15 is adjacent to the second position P2. Preferably, one end of each of the two elastic elements 14 and 15 is pivotally connected to the base 10, and the other end of each of the two elastic elements 14 and 15 is leant against the base 10. Thus, when the adapting portion 13 (referring to FIG. 2B) is moved against the two elastic element 14 and 15 and presses and deforms the two elastic elements 14 and 15, one end of each of the two elastic elements 14 and 15 fixed on the base 10 is rotatable, and the other end is slightly deformed and slides along the base 10.

Besides, at least one of the two elastic elements 14 and 15 has a bending structure, and there is at least one minimum interval of the two elastic elements 14 and 15 between the first position P1 and the second position P2. The present embodiment of the invention is exemplified that both of the two elastic elements 14 and 15 have a bending structure. The two elastic elements 14 and 15 can be S-shaped structures. Or, the two elastic elements 14 and 15 can have the design of more than two smaller intervals existed between the first position P1 and the second position P2, such that the elastic elements 14 and 15 have at least one indent used as a stopping point for halting the sliding element 11. Such design is elaborated by accompanying drawings. Despite the elastic portion 12 that has two elastic elements 14 and 15 in the present embodiment of the invention, the two elastic elements 14 and 15 can be formed by bending a single elastic element.

The design of the sliding element 11 is elaborated in FIG. 2B. When the sliding element 11 is assembled to the base 10, the adapting portion 13 of the sliding element 11 is preferably positioned between the two elastic elements 14 and 15. The adapting portion 13, for example, comprises two pins 16 and 17 respectively against the inner sides of the two elastic elements 15 and 14. When the sliding element 11 slides, the two pins 16 and 17 press and deform the elastic elements 14 and 15. The two pins 16 and 17 are tightly embedded into the small holes on the sliding element 11 for being fixed on the sliding element 11. The adapting portion 13 has two pins 16 and 17 in the present embodiment of the invention for illustration. However, in other embodiments, any design of protrusions on the sliding element 11 and coupled with the elastic elements 14 and 15 such that the sliding element 11 is movable is within the scope of the invention.

As indicated in FIGS. 2A˜2B, the base 10 further includes two sliding tracks 18 and 19 positioned on the two side edges of the base 10 for coupling with the sliding element 11. The sliding element 11 further includes two sliding media 20 and 21 disposed on the two side edges of the sliding element 11. The two sliding media 20 and 21 both have a sliding member with a sliding recess coupled with the two sliding tracks 18 and 19 on the base 10. The base 10 and the sliding element 11 are normally formed by metal plates through pressing process. When one metal plate slides on another metal plate, the two metal plates are easily damaged by each other. Therefore, with the help of the sliding media 20 and 21, the problem stated above is avoided. The sliding media 20 and 21 are preferably made of plastics with lubricating effect to enhance the stability when the sliding element 11 slides relatively to the base 10.

The sliding hinge 1 further includes a first limiting portion and a second limiting portion, wherein the first limiting portion is disposed on the base 10 and located at the first position P1, and the second limiting portion is disposed on the base 10 and adjacent to the second position P2. The first limiting portion and the second limiting portion are for avoiding the sliding element 11 coming off the base 10. The first limiting portion includes at least one stopper. In the present embodiment of the invention, two stoppers 22 and 23 are disposed on the base 10 for example. The top surface of the two stoppers 22 and 23 is not parallel to the top surface of the base 10, such that the sliding element 11 does not come off the base 10 at the first position P1. The two stoppers 22 and 23 and the base 10 can integrally formed in one piece. The second limiting portion includes a first backing pin 24 disposed on the base 10. A second backing pin 25 is disposed on the sliding element 11. When the sliding element 11 slides towards the second position P2, the first backing pin 24 will stop the second backing pin 25, such that the sliding element 11 does not come off the base 10 at the second position P2. The first backing pin 24 and the second backing pin 25 can also be tightly fixed on the base 10 and the sliding element 11. In the present embodiment of the invention, the first backing pin 24 is disposed adjacent to the second position P2. However, in other embodiments, the first backing pin 24 can be disposed at different positions on the base 10 according to the sliding course of the sliding element 11.

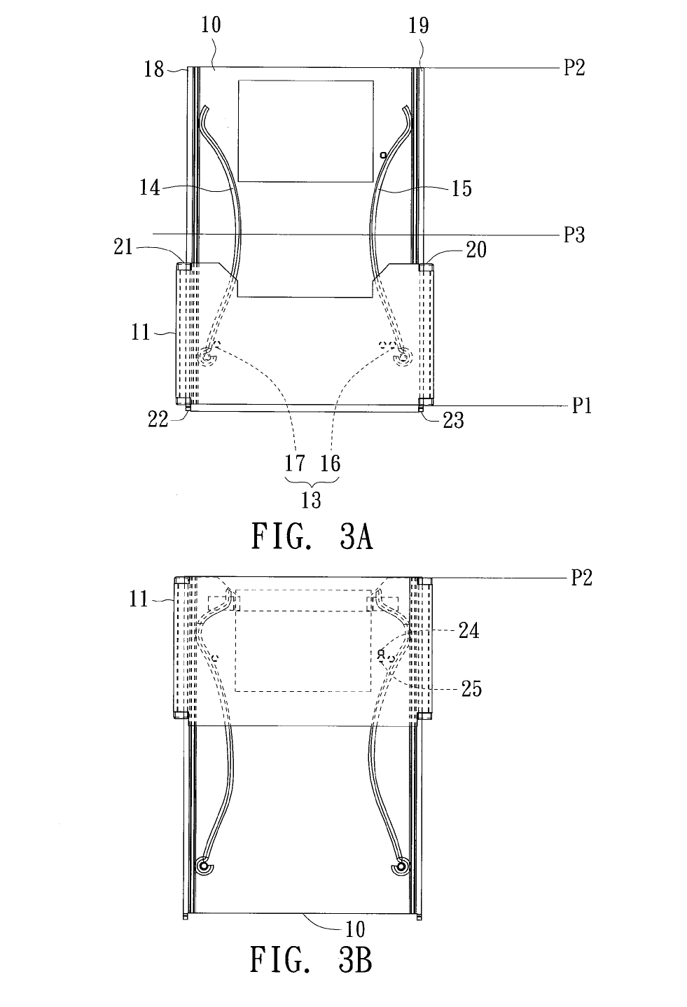

The movement between the sliding element 11 and the base 10 is elaborated below. Refer to FIGS. 3A˜3B. FIG. 3A is a perspective of the sliding element in FIG. 1 at the first position. FIG. 3B is a perspective of the sliding element in FIG. 1 at the second position. As indicated in FIG. 3A, when the sliding element 11 is at the first position P1, the adapting portion 13 exactly contacts the two inner sides of the elastic element 14 and 15. Besides, the two stoppers 22 and 23 positioned at the first position P1 are for avoiding the sliding element 11 coming off the base 10. When a force is applied to the sliding element 11 such that the sliding element 11 slides towards the second position P2 by means of the sliding tracks 18 and 19 and the sliding media 20 and 21 disposed at two lateral sides, the two pins 16 and 17 on the sliding element 11 will push the elastic element 14 and 15 outwards, the elastic element 14 and 15 will provide an elastic force to the two pins 16 and 17. When the sliding element 11 continues to slide over a middle position P3 on the base 10, as parts of the elastic elements 14 and 15 are disposed under the two pins 16 and 17, the deformed elastic elements 14 and 15 will push the two pins 16 and 17 upwards, such that the sliding element 11 will automatically slide towards the second position P2. When the sliding element 11 slides to the second position P2 as indicated in FIG. 3B, the first backing pin 24 disposed on the base 10 will interfere with the second backing pin 25 disposed on the sliding element 11, such that the sliding element 11 will stop at the second position P2 and will not come off the base 10.

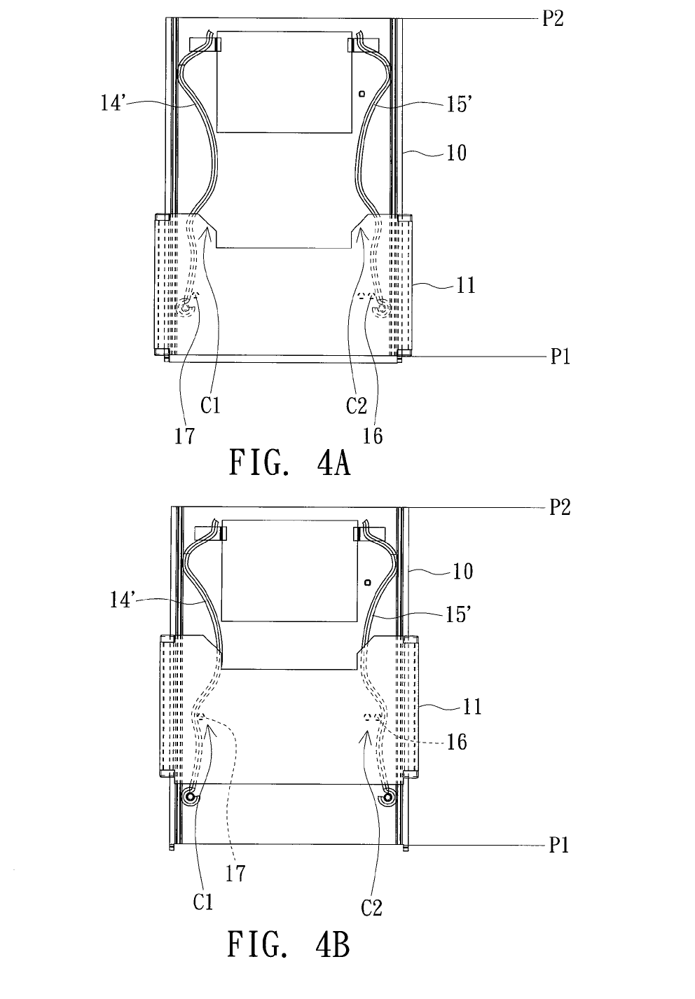

With appropriate design of the elastic elements 14 and 15, the sliding element 11 can have a plurality of stopping points on the base 10. Referring to FIG. 4A˜4B, two perspectives showing the movements of the sliding hinge with stopping point design for the sliding element are shown. As indicated in FIG. 4A, the elastic elements 14′ and 15′ can have two smaller intervals between the first position P1 and the second position P2. For example, each of the elastic elements 14′ and 15′ is like to be formed by combining two S-shaped structures. As the elastic elements 14′ and 15′ respectively have the indents C1 and C2, the sliding element 11 is engaged with the indents C1 and C2 via the pins 16 and 17 when the sliding element 11 slides as indicated in FIG. 4B. In other embodiments, the elastic elements 14′ and 15′ can have more indents, such that the sliding elements 14′ and 15′ can have multi-stage stopping points on the base 10.

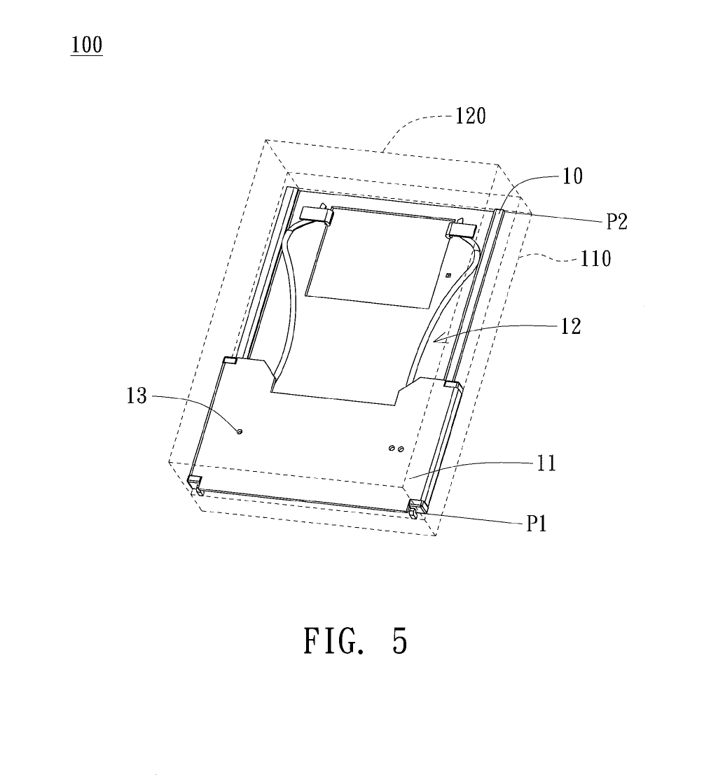

The sliding hinge 1 can be used in an electronic device constituted by two assemblies. Examples of the electronic device include slide type mobile phone, personal digital assistant (PDA) and digital camera. Referring to FIG. 5, a diagram of an electronic device of the invention is shown. As indicated in FIG. 5, the base 10 and the sliding element 11 are respectively disposed on a first assembly 110 and a second assembly 120 of the electronic device 100, wherein the first assembly 110 has the lower casing of the electronic device 100 and the second assembly 120 has the upper casing of the electronic device 100. The base 10 and the sliding element 11 are coupled together. When the user applies a force to push the first assembly 110 or the second assembly 120, the first assembly 110 slides relatively to the second assembly 120 via the base 10 and the sliding element 11. Besides, by the elastic portion 12 and the adapting portion 13, the user has smooth handling when operating the first assembly 110 and the second assembly 120.

As the electronic device has diversified functions, the design of multiple stopping points can fit user's needs when determining the positions of the multiple stopping points. Normally, the components of the first assembly are different from that of the second assembly. The stopping points of the sliding hinge 1 provide the user with more flexible selections in operation. For example, the first assembly further has an operation keypad and an audio/video play interface disposed thereon, and the second assembly has a display screen disposed thereon. The electronic device can be designed in the manner that when the second assembly slides to a stopping position, only the operation keypad is exposed. When the second assembly is completely slided, both the operation keypad and the audio/video playback interface are exposed.

The invention has the following advantages:

1. The two elastic elements of the elastic portion are directly fixed on the base before the sliding element is mounted to the base. Compared with the prior art that has to fix the two ends of a plurality of spring pieces or torsional springs on the sliding body and the body respectively, the invention uses fewer parts and the assembly is much easier and faster.

2. The structure of the elastic element is very simple. Compared with the torsional spring used in the prior art, the elastic element of the present embodiment can determine design parameters without complicated calculation. Besides, only two elastic elements are needed. A single elastic element with bending would also have the same function. The manufacturing cost for the elastic element of the embodiment is low.

3. The design of sliding hinge with multiple stopping points can be realized by changing the shape of the elastic element of the elastic portion. The electronic product can have more versatile functions.

According to the sliding hinge and the electronic device using the same disclosed in the above embodiments of the invention, the base and the sliding element of the sliding hinge are respectively disposed on the first assembly and the second assembly of the electronic device. As the base is coupled with the sliding element, the first assembly slides relatively to the second assembly. The adapting portion of the sliding element is against the elastic portion of the base for pressing the elastic portion when the sliding element slides. A plurality of indents can be designed in the elastic portion as stopping points for halting the movement of the sliding element. The elastic portion and the adapting portion have fewer parts and are easy to be assembled, hence further reducing manufacturing cost. The sliding hinge and the electronic device using the same of the invention are competitive products with great market potentials.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sliding hinge, comprising:
a base having an elastic portion; and
a sliding element slideably coupled with the base, wherein the sliding element comprises an adapting portion against the elastic portion;
wherein when the sliding element slides on the base, the elastic portion provides an elastic force to the adapting portion for pushing the sliding element, such that the sliding element slides between a first position and a second position on the base.

2. The sliding hinge according to claim 1, wherein the elastic portion comprises two elastic elements, and the adapting portion is positioned between the two elastic elements and against the two elastic elements.

3. The sliding hinge according to claim 2, wherein the two elastic elements are symmetrically disposed on the base.

4. The sliding hinge according to claim 2, wherein one end of each of the two elastic elements is adjacent to the first position, and the other end of each of the two elastic elements is adjacent to the second position.

5. The sliding hinge according to claim 4, wherein one end of each of the two elastic elements is pivotally connected to the base, and the other end of each of the two elastic elements is against the base.

6. The sliding hinge according to claim 2, wherein the two elastic elements are connected to each other.

7. The sliding hinge according to claim 2, wherein the adapting portion comprises two pins respectively against the two elastic elements.

8. The sliding hinge according to claim 2, wherein at least one of the two elastic elements is a bending structure, and the two elastic elements at least have one minimum interval between the first position and the second position.

9. The sliding hinge according to claim 8, wherein the two elastic elements are S-shaped structures.

10. The sliding hinge according to claim 8, wherein the two elastic elements respectively comprise a first S-shaped structure and a second S-shaped structure connected to the first S-shaped structure.

11. The sliding hinge according to claim 1, further comprising:
a limiting portion disposed on the base and adjacent to the first position for avoiding the sliding element coming off the base.

12. The sliding hinge according to claim 11, wherein the limiting portion comprises at least one stopper whose top surface is not parallel to the top surface of the base.

13. The sliding hinge according to claim 1, further comprising:
a limiting portion disposed on the base and adjacent to the second position for avoiding the sliding element coming off the base.

14. The sliding hinge according to claim 13, wherein the sliding element further comprises a first backing pin, the limiting portion comprises a second backing pin, the second backing pin presses the first backing pin for halting the movement of the sliding element.

15. The sliding hinge according to claim 1, wherein the base further comprises two sliding tracks positioned on the two side edges of the base for coupling with the sliding element.

16. The sliding hinge according to claim 15, wherein the sliding element further comprises two sliding media positioned on the two side edges of the sliding element for coupling with the two sliding tracks.

17. An electronic device, comprising:
a first assembly;
a second assembly, wherein the first assembly slides relatively to the second assembly; and
a sliding hinge as claimed in claim 1, wherein the base and the sliding element are disposed respectively on the first assembly and the second assembly.
